(19) United States
(12) Patent Application Publication
(10) Pub. No.: US 2008/0086372 A1
(43) Pub. Date: Apr. 10, 2008

(54) Contextual banner advertising

(76) Inventors: Anand Madhavan, Sunnyvale, CA (US); Matthew Carinio, San Luis Obispo, CA (US)

Correspondence Address: STATTLER - SUH PC, 60 SOUTH MARKET STREET, SUITE 480, SAN JOSE, CA, 95113, US

(21) Appl. No.: 11/546,112

(22) Filed: Oct. 10, 2006

(51) Int. Cl. G06Q 30/00

(52) U.S. Cl. 705/14

(57) ABSTRACT

A system and method to facilitate display of advertising information contextually related to web pages requested by users within a network are described. A request to display a web page is received from a user through a network. The web page and associated content information are further retrieved from a data storage module. One or more categories associated with the web page are retrieved from the data storage module based on the context information of the web page. Advertisements related to the URL of the web page and the associated page category or categories are next retrieved from an advertising storage module. Finally, the web page, the associated content information, and the related advertisements are transmitted to the user for further display on the user's client machine.

### TECHNICAL FIELD

The present invention relates generally to the field of network-based communications and, more particularly, to a system and method to facilitate display of advertising information contextually related to web pages requested by users within a network, such as the Internet.

### BACKGROUND OF THE INVENTION

The explosive growth of the Internet as a publication and interactive communication platform has created an electronic environment that is changing the way business is transacted. As the Internet becomes increasingly accessible around the world, users need efficient tools to navigate the Internet and to find content available on various websites.

In a typical content management system, users make requests for content, or search queries, such as, for example, published data available at various websites, or simply request a web page view by clicking on a link with a conventional mouse click command. The users subsequently receive the requested content and additional content that may or may not be relevant to the requested content or to the specific user, such as, for example, advertising content associated with advertising entities having a presence on the Internet.

### SUMMARY OF THE INVENTION

A system and method to facilitate display of advertising information contextually related to web pages requested by users within a network are described. In embodiments described in detail below, a request to display a web page is received from a user through a network. The web page and associated content information are further retrieved from a data storage module. One or more categories associated with the web page are retrieved from the data storage module based on the context information of the web page. Graphical advertisements related to the URL of the web page and the associated page category or categories are next retrieved from an advertising storage module. Finally, the web page, the associated content information, and the related graphical advertisements are transmitted to the user for further display on the user's client machine.

In alternate embodiments described in detail below, a request to display a web page is received from a user through a network. The web page and associated content information are further retrieved from a database. The content of the web page is subsequently analyzed in real-time to extract the context associated with the web page. One or more categories associated with the web page are retrieved in real-time from a data storage module based on the extracted context information. Alternatively, the categories may be ascertained in real-time based on the extracted context information. Graphical advertisements related to the URL of the web page and the associated page category or categories are next retrieved from an advertising storage module. Finally, the web page, the associated content information, and the related graphical advertisements are transmitted to the user for further display on the user's client machine.

Other features and advantages of the present invention will be apparent from the accompanying drawings, and from the detailed description, which follows below.

### BRIEF DESCRIPTION OF THE DRAWINGS

The present invention is illustrated by way of example and not intended to be limited by the figures of the accompanying drawings in which like references indicate similar elements and in which:

FIG. 1 is a flow diagram illustrating a method to facilitate display of advertising information contextually related to web pages requested by users within a network, according to one embodiment of the invention;

FIG. 2 is a block diagram illustrating an exemplary network-based entity, which facilitates display of advertising information contextually related to web pages requested by users, according to one embodiment of the invention;

FIG. 3A is a block diagram illustrating a data storage module, such as, for example, a database, which at least partially implements and supports the network-based entity, according to one embodiment of the invention;

FIG. 3B is a block diagram illustrating an advertising storage module, such as, for example, a database, which at least partially implements and supports the network-based entity, according to one embodiment of the invention;

FIG. 4 is an interaction diagram illustrating the interaction between the network-based entity and a client machine associated with a user, according to one embodiment of the invention;

FIG. 5 is an interaction diagram illustrating the interaction between the network-based entity and a client machine associated with a user, according to an alternate embodiment of the invention;

FIG. 6 is a flow diagram illustrating a method to facilitate display of advertising information contextually related to web pages requested by users within a network, according to one embodiment of the invention;

FIG. 7 is a flow diagram illustrating a method to facilitate display of advertising information contextually related to web pages requested by users within a network, according to an alternate embodiment of the invention;

FIG. 8 is a diagrammatic representation of a machine in the exemplary form of a computer system within which a set of instructions may be executed.

### DETAILED DESCRIPTION

In embodiments described in detail below, a system and method to facilitate display of advertising information contextually related to web pages requested by users within a network are described. A typical content management system includes various high-interest vertical properties, each property being related to a predetermined content area, such as, for example, “Music” and/or “Automobiles.” Within each property, the system provides content and associated advertising information to users interested in the specific content area. However, the inventory of advertising slots within each web page is limited, as is the number of times each advertisement may be shown to the users within each corresponding advertising slot. Thus, advertiser entities usually compete for advertising slots within such vertical properties.

The content management system also includes various low-interest properties, each property being related to one or more content areas, such as, for example, “News,” “Groups,” “Blogs,” and others. The embodiments described in detail below enable the system to increase the inventory of vertically-focused advertising slots related to the high-interest properties by identifying areas within the low-interest properties, which are contextually related to the corresponding content areas of the high-interest vertical properties. In addition, the embodiments described in detail below enable the system to increase the value of the non-vertical inventory through its association with the vertically-focused inventory of advertising slots.

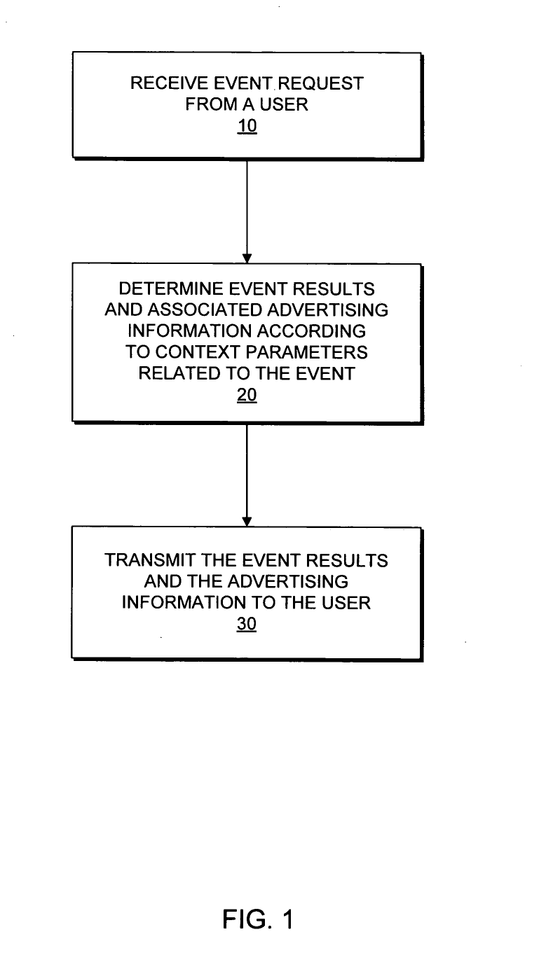

FIG. 1 is a flow diagram illustrating a method to facilitate display of advertising information contextually related to web pages requested by users within a network, according to one embodiment of the invention. As illustrated in FIG. 1, at processing block 10, an event request, such as, for example, a request for a web page or a collection of web pages, is received from a user. At processing block 20, the event request is processed, as described in further detail below, and event results, such as, for example, the requested web page or pages, and associated advertising information are determined according to context parameters related to the requested web pages. Finally, at processing block 30, the event results and the associated advertising information are transmitted to the user.

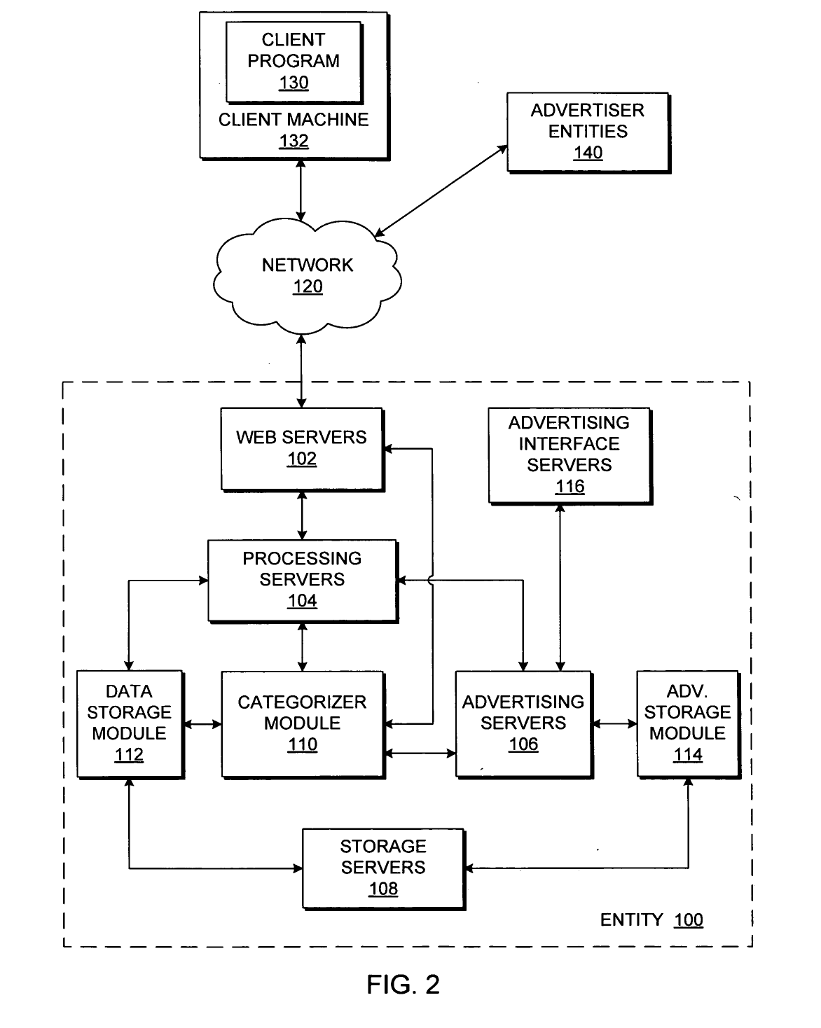

FIG. 2 is a block diagram illustrating an exemplary network-based entity 100, which facilitates display of advertising information contextually related to events requested by a user within a network. While an exemplary embodiment of the present invention is described within the context of such entity, it will be appreciated by those skilled in the art that the invention will find application in many different types of computer-based, and network-based, entities, such as, for example, commerce entities, content portal entities, or other known entities having a presence on the network.

In one embodiment, the entity 100 includes one or more front-end web servers 102, such as, for example, page servers (not shown), which deliver web pages to multiple users, (e.g., markup language documents), search servers (not shown), which handle search requests to the entity 100, and communication servers (not shown), that provide, inter alia, automated communications to/from users of the entity 100, namely, electronic mail (email) servers, which provide automated email communications to/from users, and/or real-time communication servers, such as servers providing instant messaging (IM) functionality. The entity 100 may also include any number of additional web servers, such as, for example, picture servers (not shown), which dynamically deliver images to be displayed within the web pages, and content servers (not shown), which dynamically deliver content information to the users, and other servers, which provide an intelligent interface to the back-end of the entity 100.

The entity 100 further includes one or more back-end servers, for example, processing servers 104, advertising servers 106, and database servers 108, each of which maintaining and facilitating access to one or more respective storage modules 112, 114.

In one embodiment, the processing servers 104 are coupled to the data storage module 112, such as, for example a database, which in turn is further coupled to a categorizer module 110 configured to categorize web pages according to one or more categories, and to store the categorized web pages within the data storage module 112, as described in further detail below. The advertising servers 106 are coupled to the advertising storage module 114, such as, for example, a second database, and are configured to select and transmit content, such as, for example, graphical banner advertisements, sponsor links, integrated links, and other types of advertising content, to users via the network 120, and to process advertising offers received at the entity 100, as described in further detail below.

In one embodiment, the advertising storage module 114 stores advertisements submitted by one or more advertiser entities 140 through the network 120 and the front-end advertising interface servers 116, such as, for example, contextual graphical advertisements (e.g., images, multimedia, flash ads, etc.). Initially, each advertiser entity 140 communicates with the advertising interface servers 116 and the advertising servers 106 and submits advertising offers for various properties within the entity 100.

For example, an advertiser entity 140 may offer a predetermined amount for a set number of impressions in a vertical property related to a specific content area such as, for example, “Music.” The advertiser entity 140 may further offer a predetermined lower amount for a set number of impressions in a low-interest property related to “News,” for example, and may specify a target category of interest within the “News” property, such as, for example, the “Music” category. The offers and associated advertisements are then stored within the advertising storage module 114. Thus, if a user requests a music-related web page, the advertising servers 106 may select and serve advertisements for the music-related vertical property up to the set number of impressions, and may also serve advertisements in the music-related pages of the “News” low-interest property, as specified by the advertiser entity 140.

In an alternate embodiment, an advertiser entity 140 may specify a geographical target category within the “News” property, indicating, for example, that advertisements should be selected and served for users accessing the entity 100 from a particular geographical region.

Referring back to FIG. 2, the network-based entity 100 may be accessed by a client program 130, such as a browser (e.g., the Internet Explorer browser distributed by Microsoft Corporation of Redmond, Wash.) that executes on a client machine 132 and accesses the entity 100 via a network 120, such as, for example, the Internet. Other examples of networks that a client may utilize to access the entity 100 includes a wide area network (WAN), a local area network (LAN), a wireless network (e.g., a cellular network), the Plain Old Telephone Service (POTS) network, or other known networks.

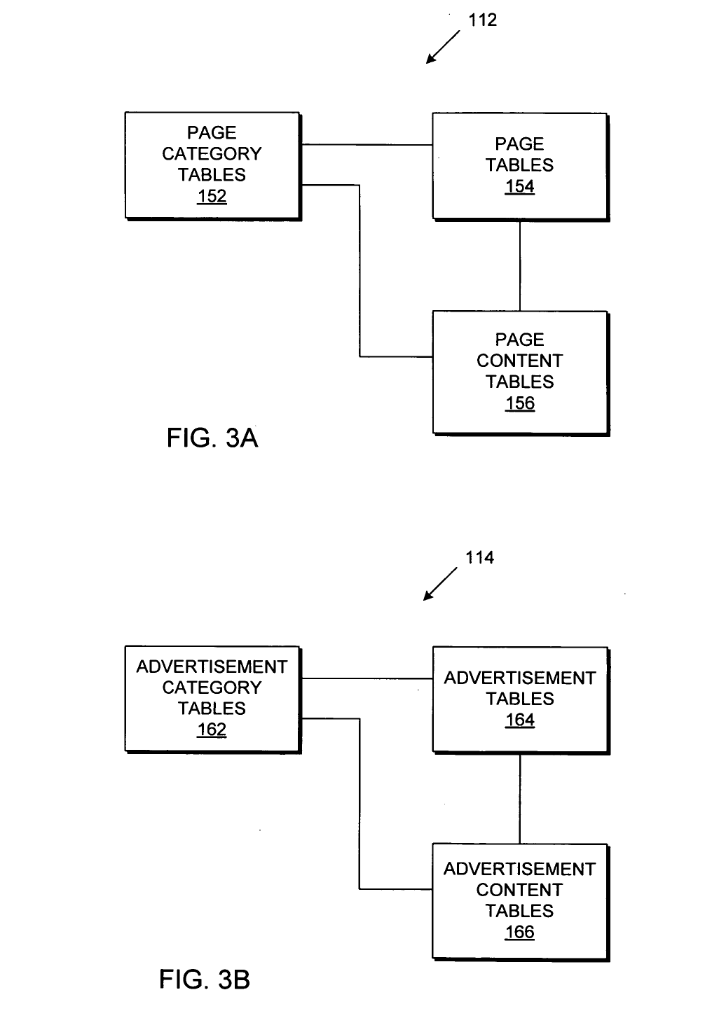

FIG. 3A is a block diagram illustrating a data storage module 112, such as, for example, a database, which at least partially implements and supports the network-based entity, according to one embodiment of the invention. As illustrated in FIG. 3A, the database 112, which is coupled to the processing servers 104 and the categorizer module 110, includes multiple tables, of which tables specifically provided to enable an exemplary embodiment of the invention, namely page category tables 152, page tables 154, and page content tables 156, are shown.

In one embodiment, the page category tables 152 may contain, for example, multiple categories used to group the web pages accessed by the processing servers 104 and/or by the categorizer module 110. The categories stored within the page category tables 152 are further organized into a hierarchical taxonomy, which is reviewed, edited, and updated automatically by the categorizer module 110, or, in the alternative, manually by editors and/or other third-party entities. For example, the taxonomy may comprise a high-level category for “music,” and several sub-categories, located hierarchically below the “music” category, and illustrating different genres of music. However, it is to be understood that any other representation of a taxonomy used to classify subject matter may be used, without deviating from the spirit or scope of the invention. In an alternate embodiment, the assigned categories may not be mapped into a hierarchical taxonomy and may instead be stored as a collection of categories within the database 112.

Similarly, the page tables 154 may store web page information related to the web pages, and the page content tables 156 may contain, for example, content associated with the web pages. For example, a “Music” page category stored within the tables 152 may be linked to various music-related web pages stored within the tables 154 and may also be linked to corresponding content stored within the tables 156.

It is to be understood that the database 112 may include any of a number of additional tables, which may also be shown to be linked to the page category tables 152, the page tables 154, and the page content tables 156, such as, for example, user tables (not shown), which store records for each entity or user of the entity 100.

In one embodiment, the categorizer module 110 receives web page information, such as, for example, the Universal Resource Locator (URL) of each web page and content associated with each web page from the web servers 102, analyzes the URL and the associated content, and categorizes each web page according to one or more categories stored within the page category tables 152. Subsequently, the categorizer module 110 stores the corresponding web page information into the page tables 154, and the associated content information into the page content tables 156.

FIG. 3B is a block diagram illustrating an advertising storage module 114, such as, for example, a database, which at least partially implements and supports the network-based entity, according to one embodiment of the invention. As illustrated in FIG. 3B, the database 114, which is coupled to the advertising servers 106, includes multiple tables, of which tables specifically provided to enable an exemplary embodiment of the invention, namely advertisement category tables 162, advertisement tables 164, and advertisement content tables 166, are shown.

In one embodiment, the advertisement category tables 162 may contain, for example, multiple advertising categories used to group the graphical advertisements received from the advertiser entities 140. The categories stored within the advertisement category tables 162 are further organized into a hierarchical taxonomy, which is reviewed, edited, and updated automatically by the advertising servers 106, or, in the alternative, manually by editors and/or other third-party entities. For example, the taxonomy may comprise a high-level category for “music,” and several sub-categories, located hierarchically below the “music” category, and illustrating different genres of music. However, it is to be understood that any other representation of a taxonomy used to classify subject matter may be used, without deviating from the spirit or scope of the invention. In an alternate embodiment, the assigned categories may not be mapped into a hierarchical taxonomy and may instead be stored as a collection of categories within the database 114.

Similarly, the advertisement tables 164 may store the graphical advertisements received from the advertiser entities 140, and the advertisement content tables 166 may contain, for example, content associated with the received graphical advertisements. It is to be understood that the database 114 may include any number of additional tables, which may also be shown to be linked to the advertisement category tables 162, the advertisement tables 164, and the advertisement content tables 166.

In one embodiment, the advertising servers 106 receive graphical advertisements from one or more advertiser entities 140. The advertising servers 106 further analyze a set of parameters associated with each graphical advertisement, such as, for example, the title of the advertisement, the description of the advertisement and any associated keywords, the name of the advertiser entity 140 that submitted the graphical advertisement, the landing web page of the advertisement, and the content of the advertisement, as well as other parameters related to the graphical advertisement, and categorize each graphical advertisement according to one or more advertising categories stored within the advertising category tables 162. In one embodiment, the advertising categories are identical with the web page categories stored within the page category tables 152.

Subsequently, in one embodiment, the advertising servers 106 store the corresponding graphical advertisement information into the advertisement tables 164, and the associated content information into the advertisement content tables 166. In an alternate embodiment, the advertiser entity 140 may indicate the specific category or categories associated with a graphical advertisement transmitted to the entity 100. Thus, the advertising servers 106 use the category information to categorize the received graphical advertisement without the need to analyze the set of parameters associated with the advertisement.

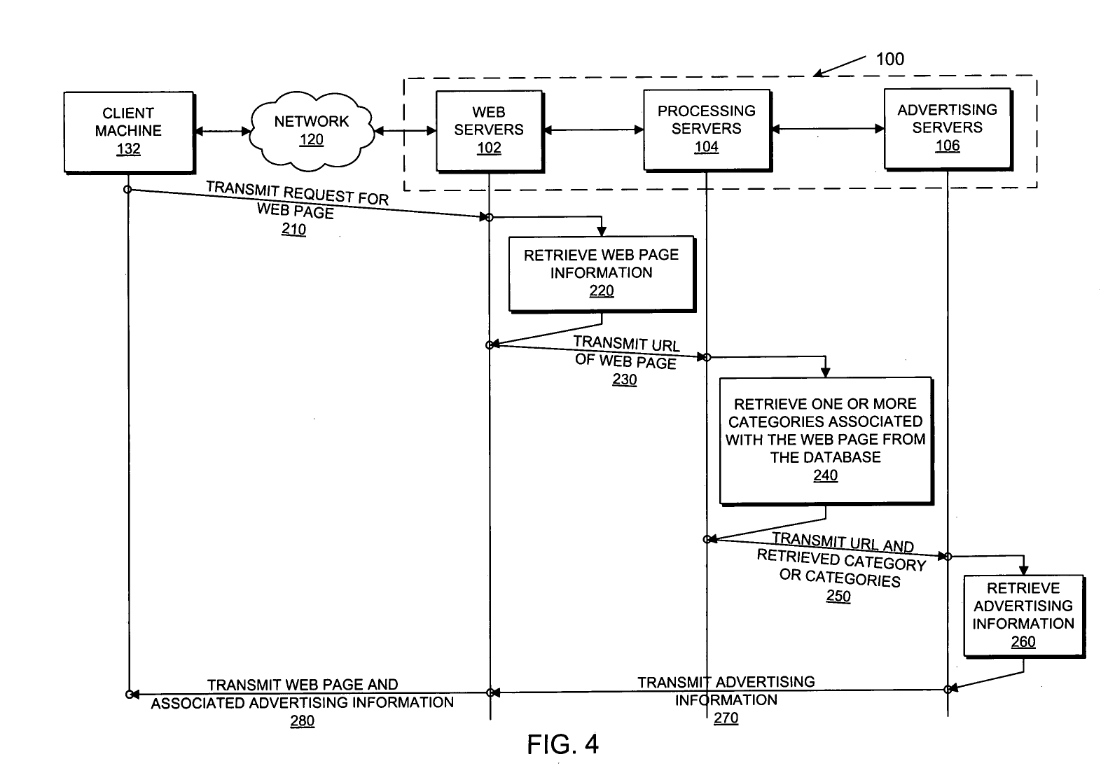

FIG. 4 is an interaction diagram illustrating the interaction between the network-based entity and a client machine associated with a user, according to one embodiment of the invention. As shown in FIG. 4, the interaction diagram starts at block 210, where the client machine 132 transmits a request for a web page, such as, for example, a web page related to a Madonna Music Tour, through the network 120 to the entity 100.

In one embodiment, at block 220, the web servers 102 within the entity 100 receive the web page request and further retrieve the web page and associated content from the corresponding page tables 154 and page content tables 156 within the database 112.

At block 230, the web servers 102 transmit the Universal Resource Locator (URL) of the requested web page to the back-end processing servers 104.

At block 240, the processing servers 104 receive the URL of the requested web page and further access the database 112 to retrieve one or more categories associated with the web page based on the context of the web page. In one embodiment, the processing servers 104 search the hierarchical taxonomy stored within the page category tables 152 of the database 112 for categories that most closely match the context of the web page and retrieve one or more categories. In one embodiment, the processing servers 104 further select a most significant category from the retrieved categories, such as, for example, a “Music” category for the requested web page. In an alternate embodiment, the processing servers 104 may retain all retrieved categories for further processing.

In one embodiment, at block 250, the processing servers 104 transmit the web page URL and the retrieved category to the advertising servers 106. In an alternate embodiment, the processing servers 104 may forward all retrieved categories to the advertising servers 106.

At block 260, the advertising servers 106 access the database 114 and use the category information and the related URL of the web page to retrieve matching advertising information from the corresponding advertisement category tables 162, advertisement tables 164, and advertisement content tables 166 within the database 114, such as, for example, graphical advertisements related to the most significant “Music” category offered by the advertiser entity 140. In alternate embodiments, the advertising servers 106 may retrieve graphical advertisements related to each category received from the processing servers 104 and/or may select graphical advertisements according to the inventory of available advertisements.

In one embodiment, at block 270, the advertising servers 106 transmit the retrieved advertising information to the web servers 102. Finally, at block 280, the web servers 102 communicate with the client machine 132 via the network 120 and transmit the requested web page, the related content, and associated graphical advertisements to the client machine 132 for further display on the client program 130.

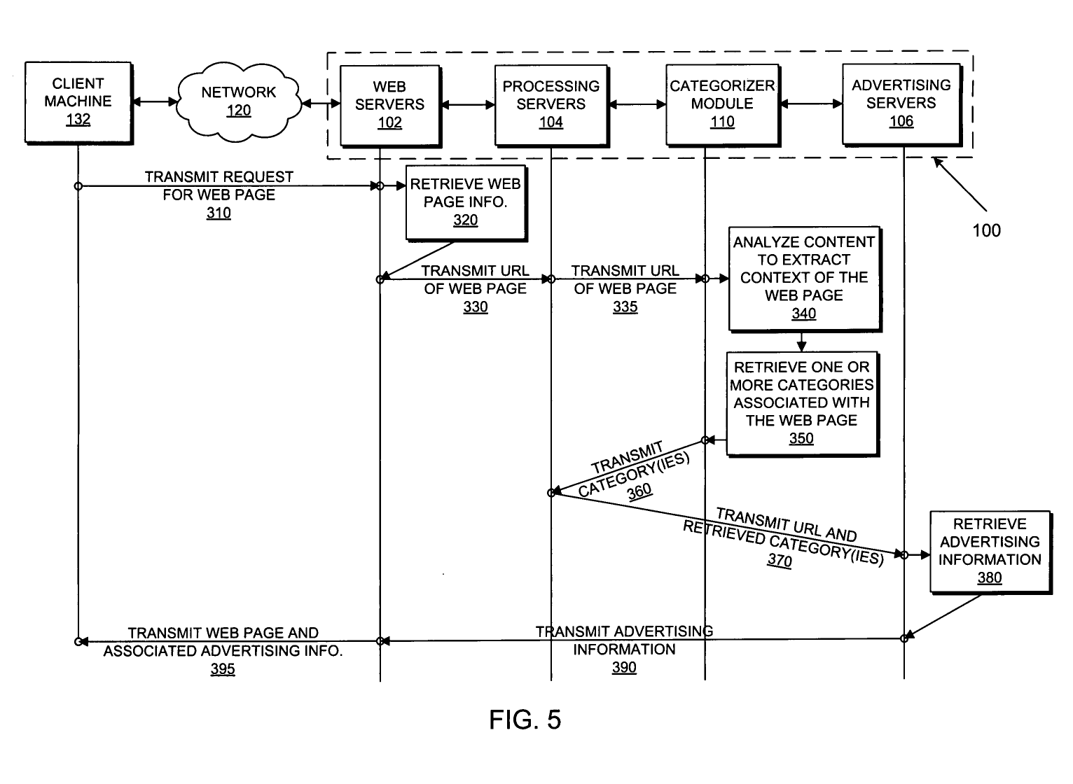

FIG. 5 is an interaction diagram illustrating the interaction between the network-based entity and a client machine associated with a user, according to an alternate embodiment of the invention. As shown in FIG. 5, the interaction diagram starts at block 310, where the client machine 132 transmits a request for a web page, such as, for example, a web page related to a Madonna Music Tour, through the network 120 to the entity 100.

In one embodiment, at block 320, the web servers 102 within the entity 100 receive the web page request and further retrieve the web page and associated content from the corresponding page tables 154 and page content tables 156 within the database 112.

At block 330, the web servers 102 transmit the Universal Resource Locator (URL) of the requested web page to the back-end processing servers 104. In one embodiment, the processing servers 104 receive the URL of the requested web page and further transmit, at block 335, a real-time request to the categorizer module 110 to provide one or more page categories associated with the requested web page based on the Universal Resource Locator (URL) of the web page.

At block 340, the categorizer module 110 receives the URL of the requested web page and analyzes the content in real-time to extract the context of the web page. In one embodiment, the categorizer module 110 employs previously stored parser entities to parse the URL in real-time and to determine associated web page context information, such as, for example, music-related events.

At block 350, the categorizer module 110 accesses the database 112 in real-time to retrieve one or more page categories from the hierarchical taxonomy stored within the page category tables 152. In one embodiment, the categorizer module 110 searches the hierarchical taxonomy stored within the page category tables 152 of the database 112 for categories that most closely match the extracted context of the web page and retrieves one or more categories. Furthermore, in one embodiment, the categorizer module 110 selects a most significant category from the retrieved categories, such as, for example, a “Music” category, for the requested web page, and transmits in real-time, at block 360, the selected category to the processing servers 104.

In an alternate embodiment, the categorizer module 110 matches a category with the extracted content without accessing the database 112 and forwards the category in real-time to the processing servers 104. In another alternate embodiment, the categorizer module 110 may retain all retrieved page categories and transmit the categories to the processing servers 104 for further processing.

In one embodiment, at block 370, the processing servers 104 receive the page category from the categorizer module 110 and further transmit the web page URL and the retrieved category to the advertising servers 106. In an alternate embodiment, the processing servers 104 may forward all retrieved categories to the advertising servers 106.

At block 380, the advertising servers 106 access the corresponding tables within the database 114 and use the category information and the related URL to retrieve matching advertising information from the database 114, such as, for example, graphical advertisements related to the most significant “Music” category, which were previously presented and stored by the advertiser entity 140. In alternate embodiments, the advertising servers 106 may retrieve graphical advertisements related to each category received from the processing servers 104 and/or may select graphical advertisements according to the inventory of available advertisements.

In one embodiment, at block 390, the advertising servers 106 transmit the retrieved advertising information to the web servers 102. Finally, at block 395, the web servers 102 communicate with the client machine 132 via the network 120 and transmit the requested web page, the related content, and associated graphical advertisements to the client machine 132 for further display on the client program 130.

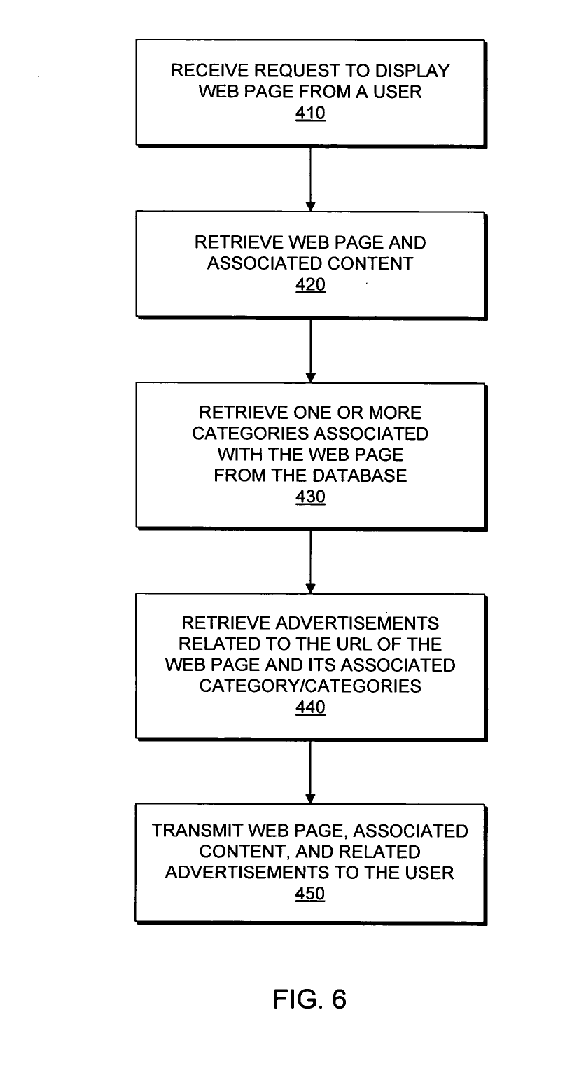

FIG. 6 is a flow diagram illustrating a method to facilitate display of advertising information contextually related to web pages requested by users within a network, according to one embodiment of the invention. As illustrated in the embodiment of FIG. 6, at processing block 410, a request to display a web page is received from a user through a network.

At processing block 420, the web page and associated content information are retrieved from a database. At processing block 430, one or more categories associated with the web page are retrieved from a database based on the context information of the requested web page. At processing block 440, advertisements related to the URL of the web page and the associated page category/categories are retrieved from a database. Finally, at processing block 450, the web page, the associated content information, and the related advertisements are transmitted to the user for further display on the user's client machine.

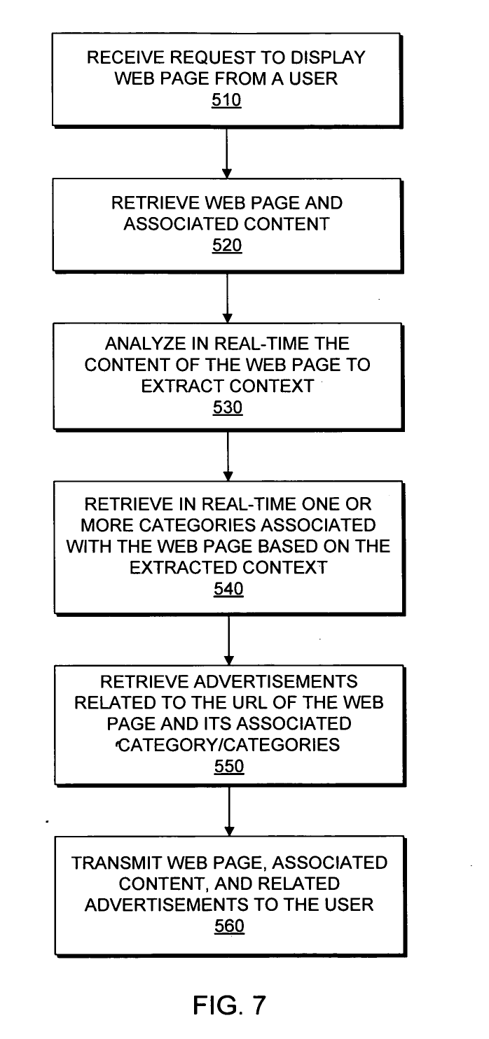

FIG. 7 is a flow diagram illustrating a method to facilitate display of advertising information contextually related to web pages requested by users within a network, according to an alternate embodiment of the invention. As illustrated in the embodiment of FIG. 7, at processing block 510, a request to display a web page is received from a user through a network.

At processing block 520, the web page and associated content information are retrieved from a database. At processing block 530, the content of the web page is analyzed in real-time to extract context information related to the web page.

At processing block 540, one or more categories associated with the web page are retrieved in real-time from a database based on the extracted context information. Alternatively, the category or categories associated with the web page are ascertained in real-time based on the extracted context information without accessing the database.

At processing block 550, advertisements related to the URL of the web page and the associated page category/categories are retrieved from a database. Finally, at processing block 560, the web page, the associated content information, and the related advertisements are transmitted to the user for further display on the user's client machine.

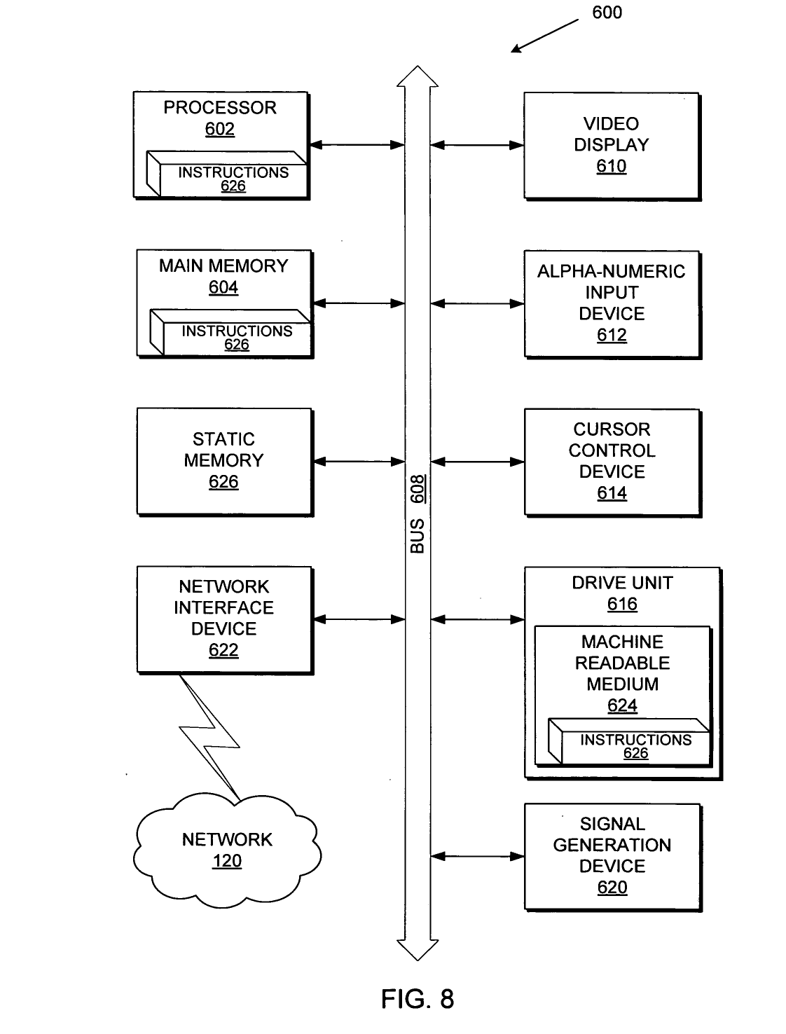

FIG. 8 shows a diagrammatic representation of a machine in the exemplary form of a computer system 600 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 600 includes a processor 602, a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker), and a network interface device 620.

The disk drive unit 616 includes a machine-readable medium 624 on which is stored a set of instructions (i.e., software) 626 embodying any one, or all, of the methodologies described above. The software 626 is also shown to reside, completely or at least partially, within the main memory 604 and/or within the processor 602. The software 626 may further be transmitted or received via the network interface device 620.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
retrieving content and graphical advertising information related to at least one category associated with said content, in response to a request for content from a user over a network, said at least one category being contextually related to said content; and
transmitting said content and said advertising information to said user.

2. The method according to claim 1, wherein said request for content further comprises a web page request received from said user.

3. The method according to claim 2, further comprising:
receiving said web page request from said user over said network; and
retrieving an Universal Resource Locator (URL) assigned to said web page and said content of said web page.

4. The method according to claim 3, wherein said retrieving further comprises:
analyzing said content of said web page to extract contextual information related to said web page; and
retrieving said at least one category from a data storage module based on said extracted contextual information.

5. The method according to claim 4, wherein said retrieving further comprises:
retrieving said graphical advertising information related to said web page from an advertising storage module based on said URL of said web page and said at least one category.

6. The method according to claim 4, wherein said retrieving further comprises:
selecting a most significant category from said at least one category; and
retrieving said graphical advertising information related to said web page from an advertising storage module based on said URL of said web page and said most significant category.

7. The method according to claim 3, wherein said retrieving further comprises:
analyzing in real-time said content of said web page to extract contextual information related to said web page; and
retrieving in real-time said at least one category from a data storage module based on said extracted contextual information.

8. The method according to claim 3, wherein said retrieving further comprises:
analyzing in real-time said content of said web page to extract contextual information related to said web page; and
matching in real-time said at least one category to said extracted contextual information.

9. An apparatus comprising:
at least one processing server to retrieve content related to at least one category associated with said content, in response to a request for content from a user over a network, said at least one category being contextually related to said content;
at least one advertising server coupled to said at least one processing server to retrieve graphical advertising information related to said at least one category; and
at least one web server coupled to said at least one processing server to transmit said content and said advertising information to said user.

10. The apparatus according to claim 9, wherein said request for content further comprises a web page request received from said user.

11. The apparatus according to claim 10, wherein said at least one web server further receives said web page request from said user over said network, and retrieves an Universal Resource Locator (URL) assigned to said web page and said content of said web page.

12. The apparatus according to claim 11, wherein said at least one processing server further analyzes said content of said web page to extract contextual information related to said web page, and retrieves said at least one category from a data storage module based on said extracted contextual information.

13. The apparatus according to claim 12, wherein said at least one advertising server further retrieves said graphical advertising information related to said web page from an advertising storage module based on said URL of said web page and said at least one category.

14. The apparatus according to claim 12, wherein said at least one processing server further selects a most significant category from said at least one category, and said at least one advertising server further retrieves said graphical advertising information related to said web page from an advertising storage module based on said URL of said web page and said most significant category.

15. The apparatus according to claim 11, further comprising a categorizer module coupled to said at least one processing server to analyze in real-time said content of said web page to extract contextual information related to said web page, and to retrieve in real-time said at least one category from a data storage module based on said extracted contextual information.

16. The apparatus according to claim 11, further comprising a categorizer module coupled to said at least one processing server to analyze in real-time said content of said web page to extract contextual information related to said web page, and to match in real-time said at least one category to said extracted contextual information.

17. A computer readable medium comprising executable instructions, which, when executed in a processing system, cause said processing system to perform a method comprising:
retrieving content and graphical advertising information related to at least one category associated with said content, in response to a request for content from a user over a network, said at least one category being contextually related to said content; and
transmitting said content and said advertising information to said user.

18. The computer readable medium according to claim 17, wherein said request for content further comprises a web page request received from said user.

19. The computer readable medium according to claim 18, wherein said method further comprises:
receiving said web page request from said user over said network; and
retrieving an Universal Resource Locator (URL) assigned to said web page and said content of said web page.

20. The computer readable medium according to claim 19, wherein said retrieving further comprises:
analyzing said content of said web page to extract contextual information related to said web page; and
retrieving said at least one category from a data storage module based on said extracted contextual information.

21. The computer readable medium according to claim 20, wherein said retrieving further comprises:
retrieving said graphical advertising information related to said web page from an advertising storage module based on said URL of said web page and said at least one category.

22. The computer readable medium according to claim 20, wherein said retrieving further comprises:
selecting a most significant category from said at least one category; and
retrieving said graphical advertising information related to said web page from an advertising storage module based on said URL of said web page and said most significant category.

23. The computer readable medium according to claim 19, wherein said retrieving further comprises:
analyzing in real-time said content of said web page to extract contextual information related to said web page; and
retrieving in real-time said at least one category from a data storage module based on said extracted contextual information.

24. The computer readable medium according to claim 19, wherein said retrieving further comprises:
analyzing in real-time said content of said web page to extract contextual information related to said web page; and
matching in real-time said at least one category to said extracted contextual information.
